(19) United States
(12) Patent Application Publication
(10) Pub. No.: US 2008/0164753 A1
(43) Pub. Date: Jul. 10, 2008

(54) METHOD AND SYSTEM FOR PROVIDING BRAKE BOOSTING IN A HYBRID MOTOR VEHICLE

(75) Inventors: Dale Crombez, Livonia, MI (US); Daniel Gabor, Canton, MI (US); Peter Worrel, Troy, MI (US); William David Treharne, Ypsilanti Township, MI (US)

Correspondence Address: Dickinson Wright PLLC, 38525 Woodward Avenue, Suite 2000, Bloomfield Hills, MI, 48304, US

(73) Assignee: Ford Global Technologies, LLC, Dearborn, MI (US)

(21) Appl. No.: 11/620,778

(22) Filed: Jan. 8, 2007

(51) Int. Cl. B60T 8/44; G06F 19/00

(52) U.S. Cl. 303/114.3; 701/70

(57) ABSTRACT

A method for providing brake boosting in a hybrid motor vehicle having a brake boosting system powered by an internal combustion engine and by an auxiliary brake boosting device includes monitoring the output of an auxiliary brake boosting device not driven by the engine, and in the event that the auxiliary brake boosting device is not operating properly, starting the internal combustion engine associated with the vehicle to provide a desired level of brake boost.

### BACKGROUND OF THE INVENTION

1. Field of the Invention

The present invention is related to a method and system for providing multiple sources for boosting service brakes in a hybrid motor vehicle, such as a hybrid electric vehicle or a hybrid hydraulic vehicle.

2. Disclosure Information

Hybrid motor vehicles, such as hybrid electric vehicles and hybrid hydraulic vehicles, provide motorists with significant fuel economy improvements. In general, hybrid electric vehicles selectively utilize both an electric traction motor and an internal combustion engine to provide motive power. Hybrid hydraulic vehicles use an engine combined with a hydraulically driven motor.

Part of the fuel economy improvement offered by hybrid hydraulic and electric vehicles arises from the fact that the internal combustion engine is shut down at various times, such as during decelerations and while the vehicle is stopped in traffic, as well as in other operating modes. Because power braking systems are usually required to be functional when the vehicle is either moving, or in a condition to move, and because many power braking systems used in hybrid vehicles rely upon a brake booster which is typically powered by means of vacuum, or air under pressure, or hydraulic fluid under pressure, it is necessary to provide an auxiliary boosting device to power the brake booster at times when the vehicle's engine is not in operation. Examples of such auxiliary boosting devices are electrodrive vacuum pumps, electrodrive air pumps or compressors, electrodrive hydraulic pumps, or hydraulically powered vacuum pumps.

Safe and convenient operation of power brake equipped vehicles having a brake booster requires that boosting be available whether the engine is operated or not. It is known to provide a switch for turning an auxiliary boosting device on and off, but such known systems do not provide for operation of the engine in the event that the auxiliary boosting device becomes disabled.

It would therefore be desirable to provide a functionally acceptable level of brake boost regardless of whether an auxiliary boosting device is operational.

### SUMMARY OF THE INVENTION

A method for providing brake boosting in a hybrid motor vehicle, such as a hybrid electric vehicle or a hybrid hydraulic vehicle, includes monitoring the value of at least one operating parameter indicative of the capability of an auxiliary brake boosting device to provide a desired output, and comparing the value of the monitored operating parameter with a predetermined range for the parameter. In the event that the value of the monitored operating parameter lies outside the predetermined range, the vehicle's internal combustion engine will be run to provide a desired level of brake boost capability. The internal combustion engine operates a boost generator such as a hydraulic pump, an air compressor, or a vacuum pump. Alternatively, the internal combustion engine may itself be operated as a vacuum pump by connecting the brake booster to an air intake manifold associated with the engine. As noted above, an auxiliary brake boosting device according to the present invention may include an electrodrive air compressor or hydraulic pump or vacuum pump, or a hydraulically driven vacuum pump.

It is an advantage of a method and system according to the present invention that power braking may be maintained with a hybrid motor vehicle notwithstanding the failure of an auxiliary brake boosting device.

It is a further advantage of a method and system according to the present invention that the fuel economy benefits of a hybrid motor vehicle may be preserved while at the same time providing safe and efficient operation of the vehicle's service brakes.

Other advantages, as well as features and objects of the present invention, will become apparent to the reader of this specification.

### BRIEF DESCRIPTION OF THE DRAWINGS

FIG. 1 is a block diagram of a system for providing brake boosting in a hybrid motor vehicle according to the present invention.

FIG. 2 is a flow chart of a method according to the present invention.

### DETAILED DESCRIPTION OF THE PREFERRED EMBODIMENTS

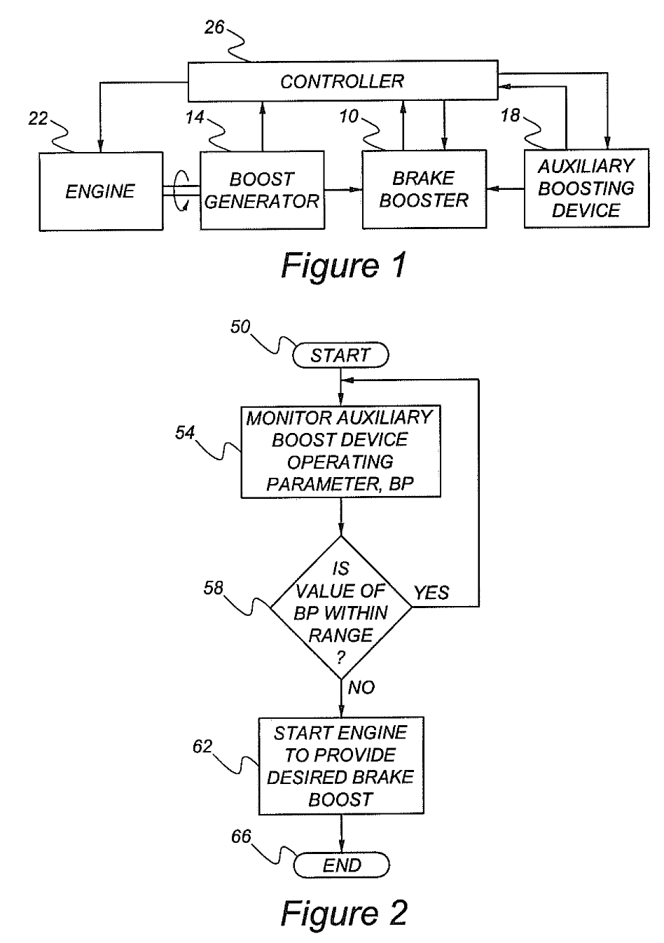

As shown in FIG. 1, brake booster 10, which may comprise either a vacuum booster or a hydraulic booster, or other type of service brake booster known to those skilled in the art and suggested by this disclosure, is powered by an internal combustion engine, 22, driving a boost generator, 14, which is connected with brake booster 10. As used herein, the term “boost generator” means either a vacuum pump, or an air compressor, or hydraulic pump driven directly by engine 22. Alternatively, the boost generator could comprise a vacuum port inserted into an intake manifold of engine 22, as is known to those skilled in the art. Controller 26, which is preferably a microprocessor controller of a type known to those skilled in the art and suggested by this disclosure, provides monitoring and control functions for the present system.

Brake booster 10 is also powered by auxiliary boosting device 18, which, as noted above, may comprise either an electrodrive vacuum pump, an air compressor, an electrodrive hydraulic pump, or a hydraulically driven vacuum pump or other device. What is important is that auxiliary boosting device 18 may be used to provide an output which powers brake booster 10 when engine 22 and boost generator 14 are normally inoperative, as when a vehicle equipped with the present system is operating with the engine off. This typically occurs when coasting, operating on a downhill grade, and braking regeneratively, as well as when the vehicle is not moving.

As shown in FIG. 2, a method according to the present invention begins at block 50 with a start, and then moves to block 54 wherein controller 26 monitors an auxiliary boost device operating parameter, BP. The operating parameter monitored at block 54 is ideally a parameter such as vacuum output from an electrodrive vacuum pump, or current consumed by a motor of an electrodrive pump, or supply current or pressure output associated with an electrodrive air compressor or hydraulic pump. As yet an alternative, BP could also comprise a pressure output of an electrodrive hydraulic pump. In any event, BP is meant to symbolize an operating parameter which indicates to controller 26, when compared with a predetermined range for such operating parameter, whether auxiliary boosting device 18 is operating properly. Such parameters are commonly known to those skilled in the art and will be suggested by this disclosure.

After monitoring auxiliary boost device 18 at block 54, controller 26 moves to block 58 wherein the value of BP is compared with a predetermined range for such value. If the value of BP is within the predetermined range, so that the answer to the question posed at block 58 is “yes”, the routine returns and continues with block 54. If, however, the answer to the question posed at block 58 is “no”, at block 62 controller 26 will start engine 22 so that engine 22, combined with boost generator 14, provides the desired brake boost. Then, the routine ends at block 66. In this manner proper boost may be provided even in the event that auxiliary boosting device 18 ceases to be operative. Those skilled in the art will appreciate in view of this disclosure that the predetermined acceptable range for BP may vary with such vehicle operating conditions as ambient atmospheric pressure, which is affected by weather conditions and altitude. The predetermined range for BP excludes implausible values, such as booster vacuum in excess of 1 atmosphere, as well as values representing loss of a control signal. Accordingly, if a signal is lost, or if the value of the signal lies outside of the expected range (i.e., is implausible), the answer at block 58 will be “no”.

According to another aspect of the present invention, engine 22 may be operated in a regime yielding maximum brake boost. This may be accomplished by, for example, controlling the load and/or speed of engine 22 independently of vehicle ground speed, or by utilizing variable valve timing, or by other methods known to those skilled in the art and suggested by this disclosure.

While particular embodiments of the invention have been shown and described, numerous variations and alternate embodiments will occur to those skilled in the art. Accordingly, it is intended that the invention be limited only in terms of the appended claims.

What is claimed is:

1. A method for providing brake boosting in a hybrid motor vehicle having a brake boosting system powered by a boost generator driven by an internal combustion engine and by an auxiliary brake boosting device, said method comprising:
monitoring the value of at least one operating parameter indicative of the capability of said auxiliary brake boosting device to provide output;
comparing the value of said monitored operating parameter with a predetermined range for said value; and
in the event that the value of said monitored operating parameter lies outside said predetermined range, running said internal combustion engine to provide a desired level of brake boost capability.

2. A method according to claim 1, wherein said auxiliary brake boosting device comprises an electrodrive vacuum pump.

3. A method according to claim 1, wherein said auxiliary brake boosting device comprises an electrodrive air compressor.

4. A method according to claim 1, wherein said auxiliary brake boosting device comprises an electrodrive hydraulic pump.

5. A method according to claim 1, wherein said auxiliary brake boosting device comprises a hydraulically driven vacuum pump.

6. A method according to claim 1, wherein said hybrid motor vehicle comprises a hybrid electric vehicle.

7. A method according to claim 1, wherein said hybrid motor vehicle comprises a hybrid hydraulic vehicle.

8. A method according to claim 1, wherein said at least one operating parameter comprises brake booster vacuum.

9. A method according to claim 1, wherein said at least one operating parameter comprises brake booster hydraulic pressure.

10. A method according to claim 1, wherein said at least one operating parameter comprises brake booster air pressure.

11. A brake system for a hybrid motor vehicle, comprising:
a brake boosting system powered primarily by an internal combustion engine;
an auxiliary brake boosting device; and
a system controller for monitoring the value of at least one operating parameter indicative of the output of said auxiliary brake boosting device, with said system controller comparing the value of said monitored operating parameter with a predetermined range for said value, and in the event that the value of said monitored operating parameter lies outside said predetermined range, running said internal combustion engine to provide a desired level of brake boost.

12. A brake system according to claim 11, wherein said auxiliary brake boosting device comprises an electrodrive vacuum pump.

13. A brake system according to claim 11, wherein said auxiliary brake boosting device comprises an electrodrive air compressor.

14. A brake system according to claim 11, wherein said auxiliary brake boosting device comprises an electrodrive hydraulic pump.

15. A brake system according to claim 11, wherein said auxiliary brake boosting device comprises a hydraulically driven vacuum pump.

16. A brake system according to claim 1 1, wherein said hybrid motor vehicle comprises a hybrid electric vehicle.

17. A brake system according to claim 1 1, wherein said hybrid motor vehicle comprises a hybrid hydraulic vehicle.

18. A brake system according to claim 11, wherein said at least one operating parameter comprises brake booster vacuum.

19. A brake system according to claim 11, wherein said internal combustion engine powers a boost generator to provide said desired level of brake boost.

20. A brake system according to claim 19, wherein said boost generator comprises a vacuum port inserted into an intake manifold of said engine, with said engine being operated in a regime which maximizes the vacuum supplied to said brake boosting system.
